(19) United States
(12) Patent Application Publication
(10) Pub. No.: US 2006/0222743 A1
(43) Pub. Date: Oct. 5, 2006

(54) CANDY-COATED BEVERAGE CONTAINER AND RELATED METHOD

(76) Inventor: Trikki Margarita loanna Bikas-Smith, Van Nuys, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/308,225

(22) Filed: Mar. 13, 2006

Related U.S. Application Data
(60) Provisional application No. 60/666,370, filed on Mar. 29, 2005.

(51) Int. Cl. A21D 10/02

(52) U.S. Cl. 426/112

(57) ABSTRACT

A method for making a candy-coated beverage container, typically a disposable cup, includes attaching a confection onto or adjacent to the rim of the container. Typically, the confection comprises a hard candy extending around the rim of the cup such that upon inserting the rim into one's mouth, the taste of the confection is imparted to the mouth.

### BACKGROUND OF THE INVENTION

The present invention generally relates to beverage containers. More particularly, the present invention relates to a beverage container, such as a disposable cup, having candy adhered to an upper portion thereof around the rim.

There exists a variety of different beverage containers. There exist bottles for infants, pre-packaged cartons of juice, water and soda, etc. There have been many inventions directed to enhancing the flavor and drinking experience of such beverages. For example, U.S. Pat. No. 3,545,980 to Stanger, and U.S. Pat. No. 4,921,713 to Fowler are directed to straws having candies or embedded therein so as to impart the candy flavoring while drinking the beverage.

U.S. Pat. No. 3,740,239 to Chancellor, is directed to a salt impregnated device for insertion on a top surface of a can, such as a can of beer, for imparting a salt flavor while drinking the beverage.

U.S. Pat. No. 6,045,833 to Landau, discloses a cover for a receptacle, such as a water bottle, which imparts a desired fragrance as the person is drinking through the receptacle cover, creating an olfactory sense deception. Somewhat similarly, U.S. Pat. No. 6,565,899 to Cecere, discloses a cover for a bottle or the like in the form of a beverage bottle cap having a lollipop edible type confection attached thereto and having an aperture extending therethrough such that the individual can suck on the confection while drinking the beverage.

U.S. Pat. No. 6,129,938 to Sweesy, discloses a method for creating a chocolate-coated beverage container having an inner-plastic sleeve comprised of shrink plastic and a tearable portion so as to remove the chocolate-coated sleeve and retain its shape, which can be eaten separately.

It is common during picnics, birthday parties, and the like to use disposable cups comprised of plastic, insulated foam, or paper. Such cups can be purchased rather inexpensively, and come in a variety of sizes to suit adults as well as small children.

The patent references discussed above would not be suitable for use with such disposable cups and containers, especially when such are used by children at birthday parties and the like. Many of these devices are directed to a specific cover or nozzle for attachment to a bottle. Oftentimes, when using disposable cups, straws are not used. As will be appreciated, coating a disposable cup with a chocolate liner or the like would create a mess.

Accordingly, there is a continuing need for a disposable cup or the like having flavoring or candy to enhance the drinking experience. Such beverage containers could be adapted for use by children so as not to be overly expensive or messy. The present invention fulfills these needs and provides other related advantages.

### SUMMARY OF THE INVENTION

The present invention generally resides in a method for making a candy-coated beverage container, such as a cup. A beverage container is provided having a rim defining an open end of the container. In a particularly preferred embodiment, a cup is provided having a base, a generally cylindrical wall upwardly from the base to the rim and defining an open end of the cup. Typically, the cup is a disposable cup comprised of a foam, plastic or paper material, such as those commonly used by children at parties and the like.

The confection is attached onto or adjacent to the rim of the container. In a particularly preferred embodiment, the confection comprises a hard candy. Upon inserting the rim of the cup into the mouth, a taste of the confection is imparted to the mouth either with the drink, or when chewing or sucking on the rim of the cup.

There are several manners of attaching candy on an upper portion onto or adjacent to the rim of the cup. For example, an open-faced groove may be formed in the rim, and the confection, typically a hard candy ring, is disposed in the open-face groove.

In another embodiment, an open-face channel is formed in the hard candy, which is configured to receive the rim of the cup therein so that the hard candy ring is disposed over or snapped into place over the rim of the cup.

In yet another embodiment, the confection is attached to the upper portion and rim of the cup by first providing a source of melted candy. The rim of the container is inserted into the melted candy. The melted candy on the rim is then allowed to harden.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of a candy-coated cup, made in accordance with the present invention and having hard candy disposed over a rim thereof.

FIG. 2 is an exploded perspective view illustrating a ring of candy and the cup.

FIG. 3 is a cross-sectional view taken generally along lines 3-3 of FIG. 2, illustrating an open-faced channel formed in the ring of candy.

FIG. 4 is a front perspective view of another candy-coated cup made in accordance with the present invention.

FIG. 5 is an exploded perspective view of the cup of FIG. 4.

FIG. 6 is a cross-sectional view taken generally along lines 6-6 of FIG. 4, illustrating a ring of candy disposed in an open-faced groove of a rim of the cup.

FIG. 7 is a perspective diagrammatic view illustrating a cup and a vat of melted candy.

FIG. 8 is a diagrammatic perspective view illustrating the insertion and removal of the cup into the melted candy, in accordance with the present invention.

### DETAILED DESCRIPTION OF THE PREFERRED EMBODIMENTS

As shown in the accompanying drawings, for purposes of illustration, the present invention resides in a candy-coated beverage container, and a method for making the same.

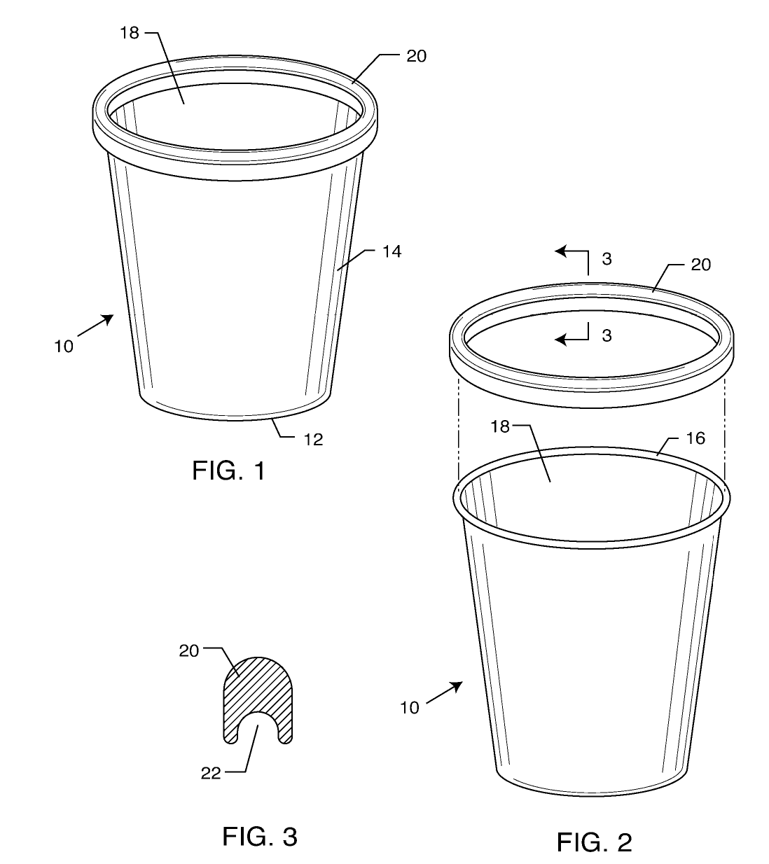

With reference now to FIG. 1, a cup 10 is illustrated. The cup includes a base 12, and a generally cylindrical wall 14 extending upwardly therefrom to define a generally circular rim 16 defining an open end 18 of the cup 10. Although the present invention could be incorporated into various types of beverage containers, in a particularly preferred embodiment, the beverage container comprises a disposable cup 10, such as those comprised of foam, paper, or plastic materials. The present invention is intended to be particularly adapted for use by children, such as children attending birthday parties and the like wherein beverage refreshments are served in disposable cups. The present invention is directed to a method for attaching a confection, such as a hard candy, onto or adjacent to the rim 16 of the cup 10 such that the children can suck on the rim 16 and enjoy the flavor and taste of the candy. This, of course, also occurs when the child is drinking from the cup as the beverage and candy flavoring mix in the mouth of the child. The present invention attaches the confection or candy only on an upper portion of the cup 10 adjacent or onto the rim 16 such that the remainder of the cup 10 is devoid of such candy so that the child can hold onto the cup without creating a mess on the child's hands.

With reference to FIGS. 1-3, in one embodiment of the present invention, a ring 20 of candy includes an open-faced groove 22 formed therein, typically in a bottom surface thereof, which is configured and sized so as to receive the rim 16 of the cup 10 therein. The attachment between the cup 10 and the ring 20 can comprise a compression or snap-fit, or the ring 20 can loosely fit onto the rim 16 of the cup 10, so long as it remains adequately in place while the cup 10 is used. Although only a partial ring 20 could be supplied and disposed over the rim 16 of the cup 10 in the area where the child is to drink from, in a particularly preferred embodiment, the ring 20 extends over the entire circumference of the rim 16.

Typically, the rim 16 is comprised of a hardened sugar-based and flavored candy. Such candies are well known and used in manufacturing lollipops and the like, and are often sold under the Lifesaver™, and Jollyrancher™ trade names, although these candies need not be of any particular brand. Although the confectionary candy rim 16 is preferably comprised of a hardened candy, it will be appreciated that the candies can also comprise other types of candy, such as “gummy” semi-hard candy and the like. The most important aspect of the present invention is that the upper rim portion 16 of the cup 10 be coated with candy for the enjoyment of the child. It is preferable, however, that the candy be sufficiently solid so as to remain on or adjacent to the upper rim 16 of the cup 10, and not melt under normal use conditions, such as room temperature and even warm summer days outside.

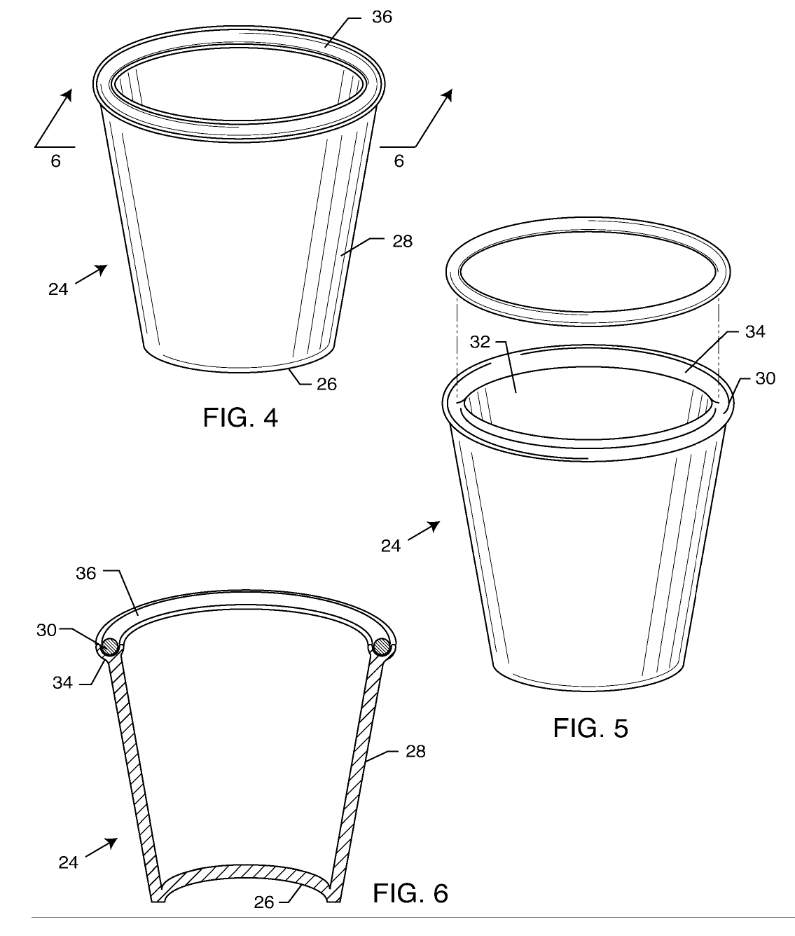

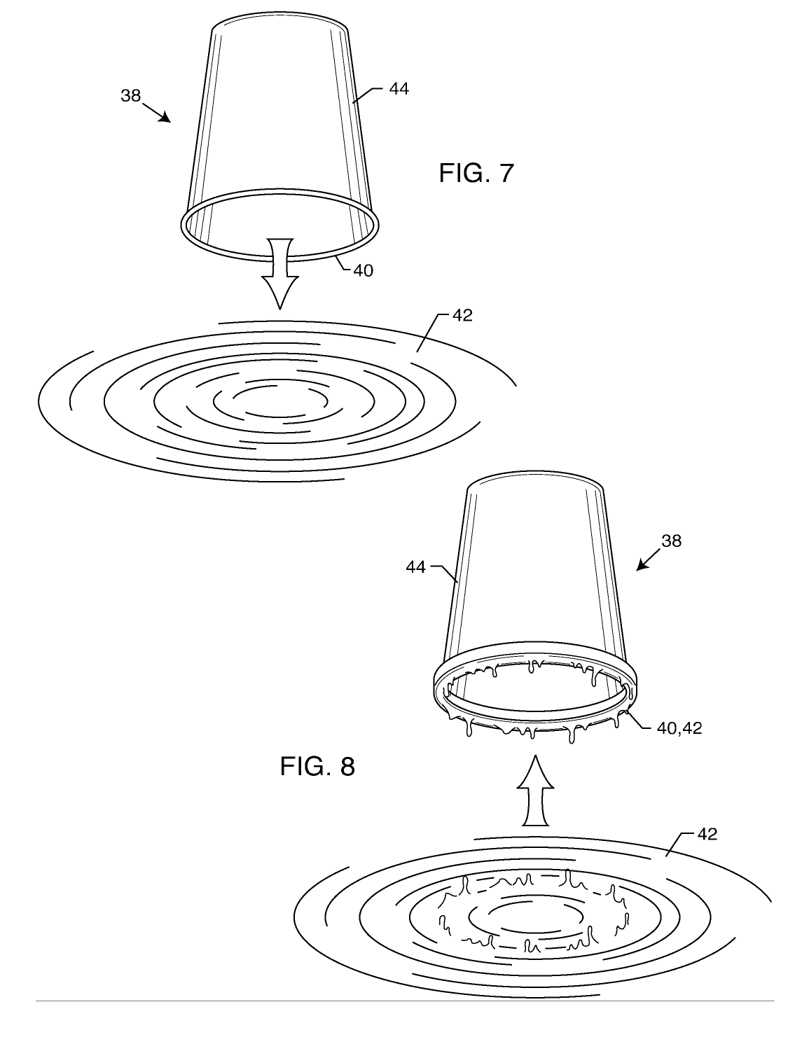

With reference now to FIGS. 4-6, another cup 24 is illustrated, also having a base 26, a generally cylindrical side wall 28 coming to a generally circular rim 30 defining an open end 32 of the cup. However, in this case, an open-faced groove or depression 34 has been formed in the rim 30, as illustrated in FIGS. 5 and 6. The open-faced groove 34 is configured and adapted to receive confections and candy therein. In a particularly preferred embodiment, a partial or whole ring of hardened candy 36 is inserted therein, as illustrated in FIG. 6. Once again, the candy 36 can comprise any type of suitable candy, as described above which can be inserted and attached to the rim 30 for the enjoyment of the child. Typically, however, as described above, the partial or full ring 36 of candy will comprise a sugar-based flavored hardened ring of candy.

With the embodiments illustrated in FIGS. 1-6, it will be appreciated by those skilled in the art that the rings 20 and 36 of candy can be either attached to the rim 16 and 30 of the cup 10 and 24 during the manufacturing process, or be offered separately either in the package of cups 10 and 24, or even sold in their own package. This is particularly the case with the embodiment illustrated in FIGS. 1-3, wherein a consumer could purchase the rings 20 of candy and insert them over a disposable cup 10 of their choice. The cup 24 illustrated in FIGS. 4-6 is of a special design and the ring 36 of candy would most likely be sold in conjunction with the cup 24. To prevent the rings 20 and 36 of candy from sticking to one another when stacked and sold, a soft sheet of plastic or the like may be placed between the rings 20 and 36 of candy, when sold together. When the rings 20 and 36 are attached to the cup 10 and 24, plastic sheets may be disposed between the stacked cups to prevent the cups from becoming stuck to one another. The plastic can be peeled away before utilizing the cups 10 and 24.

To facilitate the attachment of the rings 20 and 36 to the cup 10 and 24, the bottom portion of the ring 20 or 36 may be wetted to slightly melt the sugar-based candy before attaching it to the cups 10 and 24. Alternatively, a edible adhesive, such as a sugar-based adhesive or the like, could be used to permanently affix the rings 20 or 36 to the cup 10 or 24. This can be done during the manufacturing process, or by the parent immediately before use.

With reference now to FIGS. 7 and 8, in another embodiment, a source of melted candy 42 is provided. Such can comprise hardened candy heated to a temperature sufficient so as to melt the candy. A cup 38 is partially dipped into the melted vat of candy 42 such that the melted candy 42 adheres onto the rim 40 and the adjacent portions of the cup 38. The candy 42 is allowed to cool, such as at room temperature, and the candy hardens to form a ring or coating around the rim 40 of the cup 38. It will be appreciated that the cup 38 can be similar to the cup 10 illustrated in FIG. 2, and is preferably a disposable cup, as indicated above. However, in this case, the material comprising the cup needs to be able to withstand the elevated temperatures of the melted candy 42, and thus is preferably a plastic or paper-based disposable cup 38.

The present invention also contemplates other methods of attaching a candy to the upper rim of a cup, such as spraying a layer of candy onto and adjacent the upper rim of a cup to achieve the purposes of the present invention. Moreover, individual pieces of candy could be manually attached to the rim and adjoining area of a disposable cup, such as by using liquid sugar or edible adhesives or the like.

Regardless of the method of forming and attaching the candy on and adjacent to the rim of the cup, in use, juice or soda is poured into the cup. With each sip and drink of the beverage, the candy melts slightly and accents the taste. Of course, the candy can be sucked on, chewed or licked off without drinking the beverage as well. This brings additional enjoyment to the child and enhances the overall experience.

Although several embodiments have been described in detail for purposes of illustration, various modifications may be made to each without departing from the scope and spirit of the invention. Accordingly, the invention is not to be limited, except as by the appended claims.

What is claimed is:

1. A method for making a candy-coated beverage container, comprising the steps of providing a beverage container having a rim defining an open end of the container and attaching a confection onto or adjacent to the rim of the container, whereby upon inserting the rim into a mouth, a taste of the confection is imparted to the mouth.

2. The method of claim 1, wherein the providing step comprises the step of providing a cup having a base, a generally cylindrical wall extending upwardly from the base to the rim defining the open end of the cup.

3. The method of claim 2, wherein the cup comprises a disposable cup comprised of a foam, plastic or paper material.

4. The method of claim 1, including the step of forming an open-faced groove in the rim.

5. The method of claim 4, wherein the attaching step comprises the step of disposing the confection in the open-faced groove of the rim.

6. The method of claim 5, wherein the confection comprises a ring of hard candy.

7. The method of claim 1, wherein the confection comprises a hard candy.

8. The method of claim 7, including the step of forming an open-faced channel in the hard candy configured to receive the rim therein.

9. The method of claim 1, wherein the attaching step comprises the steps of: providing a source of melted candy;
inserting the rim into the melted candy; and
permitting the melted candy on the rim to harden.

10. A method for making a candy-coated cup, comprising the steps of: providing a cup having a base, a generally cylindrical wall extending upwardly from the base to a rim defining an open end of the cup, wherein the cup comprises a disposable cup comprised of a foam, plastic or paper material; and
attaching a hard candy confection onto or adjacent to the rim of the container, whereby upon inserting the rim into a mouth, a taste of the confection is imparted to the mouth.

11. The method of claim 10, including the step of forming an open-faced groove in the rim.

12. The method of claim 11, wherein the attaching step comprises the step of disposing the confection in the open-faced groove of the rim.

13. The method of claim 12, wherein the confection comprises a ring of hard candy.

14. The method of claim 10, including the step of forming an open-faced channel in the hard candy configured to receive the rim therein.

15. The method of claim 10, wherein the attaching step comprises the steps of:
providing a source of melted candy;
inserting the rim into the melted candy; and
permitting the melted candy on the rim to harden.
